(19) United States
(12) Patent Application Publication
(10) Pub. No.: US 2014/0273088 A1
(43) Pub. Date: Sep. 18, 2014

(54) METHOD, APPARATUS AND SYSTEM FOR STAINING OF BIOLOGICAL SAMPLES

(71) Applicant: VICTORIOUS MEDICAL SYSTEMS APS, Smorum (DK)

(72) Inventor: Lars Winther, Smorum (DK)

(21) Appl. No.: 14/352,308

(22) PCT Filed: Oct. 12, 2012
(86) PCT No.: PCT/EP2012/070284

§ 371 Date: Apr. 16, 2014

Related U.S. Application Data
(60) Provisional application No. 61/547,885, filed on Oct. 17, 2011.
(60) Provisional application No. 61/554,664, filed on Nov. 2, 2011.
(60) Provisional application No. 61/666,210, filed on Jun. 29, 2012.

(30) Foreign Application Priority Data
Oct. 17, 2011 (EP) 11185423.8

(51) Int. Cl. G01N 1/31; G01N 1/30

(52) U.S. Cl. CPC G01N 1/312; G01N 1/30
USPC 435/40.52; 422/65

(57) ABSTRACT

A method, an automated apparatus and a system for staining of a plurality of biological samples arranged on slides, e.g. for histological and cytological examination. A patient case having slides arranged in a frame is loaded into the apparatus, in which pre-treatment, including e.g. drying, baking, dewaxing and target retrieval, as well as staining, is carried out differently in respect of the slides in accordance with predetermined or operator-specified treatment protocols.

### TECHNICAL FIELD

The present invention relates to a method, an automated apparatus and a system for staining of a plurality of biological samples arranged on slides. The invention is useful for e.g. treatment of biological material for histological and cytological examination. One aspect of the invention relates to the handling and treatment of patient tissue samples mounted on microscope slides in an automated staining apparatus.

### BACKGROUND OF THE INVENTION

Cancer is a group of diseases caused by uncontrolled growth of cells followed by invasion of neighboring tissue and sometimes spreading to other parts of the body. Most cancers form tumors which can cause organ failures and are a leading cause of death globally.

Cancers are diagnosed and treated by oncologists. A definitive diagnosis often requires direct histological examination of a cancer specimen extracted by e.g. surgery, biopsy or autopsy. These specimens are examined in the anatomic pathology laboratory by staining techniques like haematoxylin and eosin (called H&E) primary staining and advanced staining, with immunohistochemistry (IHC) being the most widely used method.

Immunohistochemistry (IHC) is a technique involving the use of specific binding agents, such as antibodies and antibody fragments, to detect specific antigens that may be present in a tissue sample. Immunohistochemistry is widely used in clinical and diagnostic applications, for example to diagnose particular disease states or conditions, such as a cancer. For example, a diagnosis of a particular type of cancer can be made based on the presence of a particular marker antigen present in a sample obtained from a subject.

The anatomic pathology (AP) laboratory receives the fresh tissue or cell samples from a biopsy, surgery or autopsy. In a typical laboratory analysis workflow, the whole organ or tissue sample is dissected and described. Samples are cut (grossing) in smaller pieces and fixed in formaldehyde to preserve the structures and protect the tissue from degradation. The tissue is formalin-fixed in cassettes overnight, dehydrated in alcohol baths and embedded in paraffin blocks (tissue processing), from which thin sections (1-10 microns thick) are cut on a microtome. The formalin fixed and paraffin embedded (FFPE) tissue sections are mounted onto microscope slides and typically processed by two general pathways:

First, tissue sections are baked and dewaxed (deparaffinated) and stained by the general primary staining hematoxylin and eosin (H&E) method by treatment in a series of reagent baths in a simple and automated batch instrument. The H&E stained slides are cover slipped and examined by a pathologist using a bright field microscope for identification of cellular morphology and cytoarchitecture and diagnosis of disease states.

The rest of the slides are subjected to an optional second wave of more specific analysis, the so-called advanced staining, which visualizes specific proteins, genes or tissue structures in tissue sections selected based on the initial H&E staining.

One widely used advanced staining method is immunohistochemistry (IHC), which is an immunologically based method for visualizing proteins and structures in tissue for detection and diagnosis of cancers and other diseases. For IHC staining, the slides go through a number of complicated steps: (a) so-called baking to help adhere the thin tissue sections to the slide, (b) dewaxing to remove paraffin embedding media and fatty components in the tissue, (c) target retrieval or antigen retrieval by heat and buffer treatment or enzyme digestion, which partly reverses the effect of the previous formaldehyde fixation and also swells the tissue and (d) staining using a series of incubation with primary and secondary antibodies, numerous washing and blocking sequences, typically followed by secondary antibody-enzyme conjugates and chromogens or fluorescently tagged markers. The resulting staining pattern in the tissue is examined in a bright field or fluorescence microscope by the pathologist and is the basis for the diagnosis.

Various known histochemical and immunohistochemical stains requires the addition and removal of multiple reagents in a well defined sequence for specific time periods, at defined temperatures. Therefore, various instruments have been developed, which can perform a diversity of stains simultaneously under computer control, as specified by the technologist.

These instruments, referred to as “stainers” are robotic laboratory instruments with the capability to treat the slides with various reagents and controlled by software systems. Some stainers can perform multiple advanced staining protocols and some include the process steps of baking, dewaxing and target retrieval. Specific stainers are described below.

With regard to target retrieval procedures, no single target retrieval method or protocol is ideal for all targets to be stained. It should also be understood that the choice of optimal target retrieval method is a compromise between several factors, including the particular fixation method, preferred specific staining intensity and potentially altered tissue morphology. For a particular case, the skilled pathologist will prefer to use the best practice combination of antibodies for the particular targets, staining protocols and the best target retrieval method suited for the specific antibodies and method of tissue fixation. Currently no automated stainer instrument offers the possibility to run the most optimal protocols without sacrificing the instrument throughput to a degree where manual staining operations are more efficient.

Generally, even in highly automated anatomic pathology laboratories, the various workflows for processing the samples consist of both manual and automated processes. Even the most automated laboratories rely on the manual and timely handling, moving, sorting and loading of the samples and slides into and off the various instrument platforms to obtain an efficient workflow. The productivity demands to the sample processing workflow change over time due to variations in the general patient pressure, activities in the operation theatres, transport routines in the hospital and between departments and the availability of staff, including when the pathologists or other experts are available for the final inspection and diagnosis. Consequently, the practical manual sample and slide handling schedule, including the instrument-operator interactions, changes all the time and optimization is not straightforward.

Many of the sample data, as for example, patient ID, dates, information from grossing or biopsy and section number from the block, are shared through the laboratory information network, assisted by advanced label systems between the automated platforms. Despite this, it should be understood that the samples and slides are physically moved manually between instrument platforms in complex patterns.

Despite recent advances in software based workflow schedule optimization tools and lean processing optimization tools, the workflow in the laboratories is both stressful and demanding for the personnel as the pace is set by the ever changing external productivity demands and the cycle time of the instrument platforms. Also, as the instruments operate in a batch like mode and the process time on the platforms is long, the operators' multiple manual sample handling steps are tied to the rhythms of the instruments.

Although the anatomic pathology laboratory workflow shares some features with those found in the clinical chemistry and microbiological laboratories fundamental differences in sample handling and evaluation exist.

In clinical chemistry and microbiological laboratories samples, for example blood, urine or other samples from the patients, are distributed into a number of test tubes, vials or wells and processed by multiple procedures and on several automated platforms. The outputs from the various processes are numerical data or otherwise digitally processed data sets, which are easily combined to form the ultimate diagnosis without further need of the physical sample. This digitized output format is in strong contrast to the output in the anatomic pathology laboratory, where the processed sample slides from the entire patient case are most often inspected visually together and at the same time in order to obtain the diagnosis. The pathologist makes the diagnosis by inspecting the entire case, i.e. primary and specific staining patterns and the cell and tissue morphology of the combined slides.

Also, the slide format itself makes the instrument, procedure and handling requirements different from that of e.g. the clinical chemistry laboratory. Vials, or other tubes, can be closed and securely hold, for example, treatment reagents and transported by robotics. The slide is flat, cannot hold the reagents and the sample can easily be scratched, dry out or otherwise be damaged.

The untreated and treated slides are transported and stored in the laboratory either as single slides, on special flat trays or in so-called racks. The racks come in two general versions. The first are racks where the slides are stacked in parallel planes, forming a vertical or horizontal stack. Examples include the Sakura type slide racks or baskets (Sakura Finetek, Japan) or similar types. These racks are extensively used for both inter-laboratory transportation and in multiple brand primary (H&E) and special stains (SS) staining instruments, where all the slides in the same rack are treated with the same protocol and are compatible with automated cover slip instruments.

Another type of racks has the slides mounted next to each other in the same plane and facing the same way. Examples include the racks used in LabVision Autostainer (LabVision Corp. Fremont, Calif.-USA), which both function as an inter-laboratory transport vehicle and hold the slides during the IHC staining operation in the Lab Vision Autostainer.

Yet another slide rack used on the Symphony H&E stainer (Roche/Ventana Medical Systems, Tucson, Az.-USA) consists of a metal tray where the slides are mounted in rows as described in e.g. US2005186114A1.

It should be understood that the various racks often serve both as intermediate storage devices and as the transport vehicle between various laboratories workstations, processing instruments and sometimes as a holding device in the automated instruments. The sorting and resorting of slides into racks for particular protocols and instruments is done manually and is both laborious and error prone.

Instrument platforms used for the primary stains, including the H&E stains, resemble the advanced stainers in some features. However, for primary staining all the slides are treated with the same reagent staining protocol and target retrieval procedures are not conducted.

Some primary stainers with some limited internal slide storage capacity are known, for example the Leica XL Slide Stainer model ST501, which does primary H&E staining of slides placed in Sakura style racks. It features continuous loading and unloading of slide racks through entry and exit drawers, robotic arm delivery of slide racks to reagents in dip tanks, a water bath, and an oven. It does not possess actual internal storage although a slide rack may be stored in an empty dip tank not used in the staining operation. This will reduce the staining operation flexibility and choice of protocols.

Another similar so-called dip and dunk linear H&E stainer described in WO2006068500A1 has the theoretical capacity to hold more slides in racks internally than those being processed at the sacrifice of the flexibility of staining protocols and throughput.

Yet another primary staining instrument with a theoretical internal slide storage capacity, Symphony, marketed by Roche, and described in US 2005186114A1 allows special trays with microscope slides with mounted tissue samples to be loaded, processed and loaded off the instrument. By contrast to most other stainers, the slides in each tray are individually treated with the same staining procedure. This is a highly appreciated feature for because it avoids tissue and reagent cross contamination.

The slides loaded onto primary H&E stainers are subjected to the same process. i.e. they do not need to be sorted according to the protocol. As previously described many different protocols are applied in advanced stainers.

Fully automated IHC and ISH advanced staining instruments, which include baking, dewaxing and target retrieval procedures have been introduced by Ventana Medical Systems Inc. (BenchMark™ and Discovery™), VisionBiosystem and Leica (Bond™), Celerus (Wave RPD) and BioGenex (16000, Xmatrix DX). In general, they are built either in a so-called carousel or matrix design.

In the carousel design, the slides and reagent dispensers are arranged on different carousels and moved to each other to apply reagents to the slides. In the matrix design, the slides are stationary and treated with reagents using a sip and spit overhead robot.

Other advanced stainers of the matrix design, introduced by LabVision Corp. (Autostainer) and BioCare (intelliPath-FLX) only do the reagent staining and not the baking, dewaxing or target retrieval steps. They all need to be loaded with slides which have been pretreated.

Drawbacks with all prior art instruments include that they work as batch instruments, i.e. new slides or racks can only be loaded when a finished batch is off loaded. This requires frequent physical intervention from the operator at fixed times who must manually load and off load individual slides or pre-sorted slides.

More specifically, prior art instruments operate as physically independent instrument platforms with poor integration with the actual slide and patient case workflow in the laboratories and the real world work routines and personnel constraints.

Several of the prior art advanced stainers, such as the Bench Mark Ultra, the Bonds, Wave and the intelliPath-FLX are marketed as “continuous stainers”. Each of these instruments works in multi batch mode instruments, with the possibility to load and off load batches (1-10) of slides, partly independently of the other batches. The loading and off loading of slides is done through drawer arrangements.

This means that new slides can be manually loaded when previous slides are processed and removed. It is however important to realize that on these instruments the operator needs to walk up to the stainer and off load processed slides before new slides can be loaded.

Loading of a new batch is only possible at fixed time intervals given the duration of the processing step. If the finished slides are not removed, the instrument cannot process the next batch and therefore stands passive and unproductive.

The term “continuous stainers” is used to distinguish from single batch operating instruments, where the slides are loaded and off loaded batchwise together and the instrument operation is not to be interrupted with e.g. high priority slides.

An IHC advanced stainer design described in US200136135A1 by Dako includes a number of movable slide racks, overhead robot, various processing modules, separate loading and on loading station and a storage module. The design uses very different processing modules as compared to the preferred stainer in the present invention. For example, during target retrieval, as described in US200136135A1, the racks holding the slides are lowered into one of three large dip tanks. Therefore, all the slides in each rack are subjected to the same target retrieval treatment. Sets of slides demanding different target retrieval processes cannot be mounted on the same rack. Consequently, tissue slides from e.g. one patient case will most often need to be sorted according to target retrieval method and mounted on different racks and after processing of all the racks the slide are reassembled into the case.

The automation of staining treatments has improved the staining quality and reduced the need for manual labour, but the human operator-instrument interaction and the practical workflows still need to be improved.

One aim of embodiments of the present invention is to eliminate the drawbacks of the prior art systems by eliminating or at least reducing the need for sorting of slides, improving the operator-instrument interaction and optimizing the throughput through the staining apparatus. It is also an aim of the invention to achieve this while allowing for the flexible use of the most suited reagents and procedures for e.g. baking, dewaxing, target retrieval and staining.

On this background, it is an object of embodiments of the invention to provide an improved method and apparatus for automated staining of biological samples. In particular, it is an object of embodiments of the invention to provide a method and an apparatus, which enable efficient treatment of samples according to various treatment protocols. It is a further object of embodiments of the invention to provide a method and an apparatus, which reduce or eliminate the risk of confusing slides during staining and pre-treatment prior to staining. It is a further object of embodiments of the invention to provide a method and an apparatus, the operation of which reduces the need for manual labour work, and which, at least partially, enable the method and apparatus to perform pre-treatment and/or staining without operator-intervention.

### SUMMARY OF THE INVENTION

In a first aspect, the invention provides a method for staining of a plurality of biological samples arranged on a plurality of slides, comprising:

(a) arranging the slides in a frame to form a case, in which the plurality of slides are held in mutually fixed positions at respective sites in the frame;
(b) loading the case into an automated staining apparatus, said automated staining apparatus comprising; a processing section including a plurality of stations for pre-treatment and staining of the slides, and a storage section for storing the case when the case is outside the processing section;
(c) causing an electronic control system, which controls operation of the staining apparatus, to assign a slide identifier to each of the slides in the case;
(d) loading, into said electronic control system, a first treatment protocol for at least one of the slides within the case and a second treatment protocol for at least another one of the slides within the case, wherein each treatment protocol identifies at least one pre-treatment operation and at least one staining operation of a staining process and provides at least one process parameter value of each of said pre-treatment and staining operations, and wherein at least one process parameter value of the first treatment protocol is different from at least one process parameter value of the second treatment protocol;
(e) causing said stations of the automated apparatus to:
subject each of the slides in the case to said pre-treatment and said staining operation in accordance with said at least one process parameter, the apparatus carrying out pre-treatment and optionally staining differently in respect of at least two of the slides within the case and moves the case to and from the stations as required by the treatment protocols;
wherein the step of subjecting each of the slides to said pre-treatment comprises subjecting the slides to target retrieval operations carried out in target retrieval units, in which target retrieval is carried out while each target retrieval unit accommodates one single slide only, so as to individually control the target retrieval operations in respect of each one of the slides;
(f) unloading the case from the processing section of the automated staining apparatus;
(g) storing the case in the storage section of the automated apparatus at a point in time, which occurs before or preferably after the electronic control system has assigned a slide identifier to each of the slides in the case and:
before the case is loaded into the processing section of the automated staining apparatus; or
after completion of at least one of said pre-treatment and said staining operations, but before completion of a subsequent one of said pre-treatment and said staining operations; or
after completion of said staining operations, but before completion of a subsequent post-staining operation; or
after completion of all of said pre-treatment, said staining and said post-staining operations;
   wherein in steps (b) through (g) the slides remain secured to the frame at all times from a first point in time, when the case is being loaded into the automated staining apparatus, until a second later point in time, when the case has been removed from the automated staining apparatus.

In a second aspect, the invention provides a method for staining of a plurality of biological samples arranged on slides, comprising:
arranging the slides in a frame, in which the slides are held in mutually fixed positions at respective sites;
loading the frame with the slides into an automated staining apparatus comprising a plurality of stations for pre-treatment and staining of the slides;
causing an electronic control system of the staining apparatus to assign a slide identification insignia, such as a slide identifier, to each of the slides in the frame;
loading, into said electronic control system, a first treatment protocol for at least one of the slides and a second treatment protocol for at least another one of the slides, wherein each treatment protocol identifies at least one pre-treatment operation and at least one staining operation of a staining process and provides at least one process parameter value of each of said pre-treatment and staining operations, and wherein at least one process parameter value of the first treatment protocol is different from at least one process parameter value of the second treatment protocol;
causing said stations of the automated apparatus to subject each of the slides to said pre-treatment and said staining operation in accordance with said at least one process parameter, whereby the apparatus carries out pre-treatment and/or staining differently in respect of at least two of the slides and moves the slides to and from the stations as required by the treatment protocols;
   unloading the frame with the slides from the automated staining apparatus.

In a third aspect, the invention provides an automated apparatus for staining of a plurality of biological samples arranged on slides, comprising:
a structure for supporting a frame for holding the slides in mutually fixed positions at respective sites;
an electronic control system configured to (i) label each of the sites with a site identification insignia, i.e. to assign a site identifier to each of the sites, (ii) label each of the slides with a slide identification insignia, i.e. to assign a slide identifier to each of the slides, and (iii) associate each of the slide identifications insignias with the site identification insignia of the site holding the slide; the electronic control system further comprising data input structure for receiving a first treatment protocol for at least one of the slides and a second treatment protocol for at least another one of the slides, the treatment protocol identifying at least one pre-treatment operation and at least one staining operation of a staining process and providing at least one process parameter value of each of said pre-treatment and staining operations, wherein at least one process parameter value of the first treatment protocol is different from at least one process parameter value of the second treatment protocol;
a plurality of stations, each station comprising structure for carrying out at least one of said pre-treatment and staining operations, respectively, and each station being configured to receive control signals from said electronic control system, so as to perform the pre-treatment and staining operations of each of the slides in accordance with the treatment protocol, whereby the apparatus carries pre-treatment and/or staining out differently in respect of at least two of the slides;
a conveyor system configured to position the frame and the slides relative to the stations in a sequence prescribed by said treatment protocol and in response to control signals provided by the electronic control system.

In a fourth aspect, the invention provides an automated apparatus for staining of biological samples arranged on a plurality of slides, comprising

(a) a structure for supporting a frame for holding the slides in mutually fixed positions at respective sites, wherein the frame with the slides forms a case;
(b) a processing section including a plurality of stations for pre-treatment and staining of the slides;
(c) an electronic control system configured to control operation of the staining apparatus and to assign a slide identifier to each of the slides in the case;
(d) an electronic memory operatively associated with the electronic control system comprising, the electronic memory storing a first treatment protocol for at least one of the slides within the case and a second treatment protocol for at least another one of the slides within the case, wherein each treatment protocol identifies at least one pre-treatment operation and at least one staining operation of a staining process and provides at least one process parameter value of each of said pre-treatment and staining operations, and wherein at least one process parameter value of the first treatment protocol is different from at least one process parameter value of the second treatment protocol;
(e) a plurality of target retrieval units for carrying out target retrieval in respect of each of the slides, each target retrieval unit being configured to accommodate one single slide only at a time; said control system and target retrieval units being configured to individually control the target retrieval operations in respect of each one of the slides; said stations of the automated apparatus being configured to subject each of the slides in the case to said pre-treatment and said staining operation in accordance with said at least one process parameter, so as to allow the apparatus to carry out pre-treatment and optionally staining differently in respect of at least two of the slides within the case and to cause the case to be moved to and from the stations as required by the treatment protocols;
(f) structure for allowing the case to be unloaded from the processing section of the automated staining apparatus;
(g) a storage section for storing the case when the case is outside the processing section, the control system being configured to store the case in the storage section of the automated apparatus at a point in time, which occurs before or preferably after the electronic control system has assigned a slide identifier to each of the slides in the case and:
before the case is loaded into the processing section of the automated staining apparatus; or
after completion of at least one of said pre-treatment and said staining operations, but before completion of a subsequent one of said pre-treatment and said staining operations; or
after completion of said staining operations, but before completion of a subsequent post-staining operation; or
after completion of all of said pre-treatment, said staining and said post-staining operations;
   wherein the apparatus is configured to handle the case with the slides remain secured to the frame at all times from a first point in time, when the case is being loaded into the automated staining apparatus, until a second later point in time, when the case is unloaded from the automated staining apparatus.

Thanks to the provision of the first and second treatment protocols, at least two of the slides may be differently treated according to the first and second treatment protocols. This improves operator convenience and handling efficiency of slides, because slides to be treated differently may be included in the same frame. For example, respective tissue samples originating from one patient arranged at a plurality of slides may be loaded together into the apparatus in the frame and unloaded together from the apparatus, even though they are pre-treated and/or stained differently. Accordingly, the operator's need for arranging or sorting the slides is reduced, and the risk of confusing patients' slides is considerably reduced as well. Within the automated apparatus, slides may or may not be removed from the frame for pre-treatment and/or staining thereof, however all slides of any given frame are loaded together into the apparatus, while they are arranged in the frame, and they are offloaded together, while they are arranged in the frame. Hence, even though the slides in a single frame are treated differently according to the first and second treatment protocols, an operator of the apparatus experiences that the slides are loaded and offloaded together, and the risk of confusing slides is hence reduced.

The method according to the first aspect of the invention and the apparatus according to the fourth aspect of the invention allow each case to be treated in a manner, in which the case is loaded into the apparatus as one single unit and unloaded from the processing section thereof as one single unit, without the slides leaving the case between loading and unloading of the case to/from the apparatus and/or the processing section thereof. Accordingly, user convenience is improved, the need for manual user interaction is reduced, and the risk of confusing slides between loading and unloading is eliminated. The ability of individually controlling pre-treatment, notably target retrieval of each of the slides of each case allows the case to be collected of slides, which require different pre-treatment conditions, whereby the throughput of the apparatus is improved. Further, the need for pre-sorting and post-sorting of slides is eliminated. The ability of the method and apparatus to store one or more cases further improves user convenience and handling efficiency, because cases having low priority may be taken out for intermittent storage to allow other cases with high priority to be processed. The corresponding priority schedule of the cases may be loaded into the control system of the apparatus by a user via a user interface of the apparatus or via an external device through a communication interface. Preferably, the control system is configured to benefit from the storage section at any instance throughout the cases' way through the apparatus, i.e. to offload one or more cases for storage
before the case is loaded into the processing section of the automated staining apparatus;
after completion of at least one of said pre-treatment and said staining operations, but before completion of a subsequent one of said pre-treatment and said staining operations;
after completion of said staining operations, but before completion of a subsequent post-staining operation; and
after completion of all of said pre-treatment, said staining and said post-staining operations.

However, embodiments are envisaged, in which the control system is configured to allow storage at one of the above instances only.

It will be understood from the above discussion that a plurality of slides may be arranged into a plurality of frames to form a plurality of cases, each case holding a plurality of slides in mutually fixed positions at respective sites in the frame.

Accordingly, at (b) at least two of the plurality of cases may be loaded from the storage section to the processing section of the automated apparatus, and at (c), (d) and (e) at least two cases may be simultaneously processed at respective stations within the processing section of the automated apparatus.

In one embodiment one single case at a time is being processed at each of said stations within the processing section of the automated apparatus.

At least a first one of the cases may be retained in the storage section of the automated apparatus, while at least a second one of said cases is being processed in the processing section of the automated apparatus.

In the method and apparatus of the invention the electronic control system may store a priority schedule for pre-treatment and staining of the cases, whereby the plurality of cases may be subjected to pre-treatment and staining according to said priority schedule. The automated staining apparatus may comprise a communication interface allowing changes to the priority schedule, while the plurality of cases are within the apparatus. In the event of a change to the priority schedule, the method and apparatus may be configured to
at (g): intermittently store at least a first one of the cases at the storage section before processing of that case at the pre-treatment and staining stations has been completed, or before processing of that case at a post-staining station has been completed;
process, at said stations for pre-treatment, staining and/or post-staining, at least a second one of the cases, which has received higher priority than the first case, while the first case remains stored at the storage section;
reload the first case from the storage section to the processing section of the automated staining apparatus upon completion of processing of the second case.

Subsequent to reloading of the case, the first case may be processed at one of said stations, while the second case is simultaneous being processed at a second one of said stations.

In one embodiment of the invention, a first set of slides in the frame may be pre-treated by drying, baking, dewaxing and target retrieval at a first set of process parameters and subsequently stained at a first staining process parameter, whereas a second set of slides in the frame may be pre-treated by drying, baking, dewaxing and target retrieval at a second set of process parameters and subsequently stained at a second staining process parameter. The process parameter value may include any variable in the pre-treatment and staining operations, including but not limited to values of one or more of the following parameters:
temperature (preferably below 60° C.), time, temperature-time profile, relative humidity, number of slides, flow rate of air, airflow distribution and speed in respect of drying and baking;
type of dewaxing solvent and rehydration solvent mixture, contact time, dispensed volume, number of repeated treatments, temperature, efficiency of solvent removal in respect of dewaxing and rehydration;
temperature and temperature distribution, incubation time, temperature-time profile, pH of target retrieval buffer, type and concentration of detergents, salts and metal chelating reagent in respect of target retrieval in HIAR in dip tanks;
enzyme type and concentration, incubation time, temperature, time, temperature-time profile, dispensed volume, pH of enzyme buffer in respect of target retrieval in enzymatic treatment in a staining module;
type of primary reagent, antibody species and sub type, clone number, incubation time, temperature, concentration, antibody diluents buffer (pH, enhancers, salts), dispensed volume, visualization conjugate type (binding entities, enzymes, color, flourophor etc), concentration, incubation time, temperature, diluent buffer (pH, enhancers, salts), dispensed volume, wash buffer (pH, detergents, salts), dispensed wash buffer volume, number and efficiency of wash cycles, temperature, chromogen type, concentration of active reagents, type of chromogen enhancer, dispensed volume, temperature, number of dispensed chromogen portions and number of repeated applications, type of counterstaining reagent, concentration, incubation time, temperature, pH of reaction buffer, dispensed volume, type of dehydration/clearing agent, incubation time, dispensed volume, number of repeated treatments in respect of staining in IHC.

The slides may include microscope slides known per se. The frame may include a rack or a so-called case known per se, or any other suitable structure for holding the slides in mutually fixed positions at respective sites. The sites may be constituted by slots in a rack, which includes fixtures, such as clamps, for securing the slides in the slots. The automated staining apparatus, which constitutes an independent aspect of the present invention, includes a plurality of stations for pre-treatment and staining. Preferably, respective stations are provided for baking, dewaxing, target retrieval and staining. However, one or more of the stations may be configured to carry out only part of said pre-treatment and staining operations, and one or more of the stations may be configured to carry out more than one pre-treatment and/or staining operation.

The method and apparatus of the present invention are preferably controlled by an electronic control system of the automated staining apparatus. The control system may be integrated with and/or housed in the apparatus, or it may be provided as an external computer or computer network, which communicates with the apparatus via one or more electronic communication ports. The control system may comprise an electronic processor and an electronically accessible memory. The apparatus may comprise structure for moving the slides and/or the frame relative to the stations under the control of the electronic control system. For example, an electronically controllable conveyor or transport system may be provided for moving the frame and/or the slides between the stations of the apparatus. The transport system may, in one embodiment of the invention, be configured to remove any one of the slides or any set of slides from the frame, while the frame remains supported in or by the apparatus. For example, a first set of slides may be removed from the frame for pre-treatment thereof by baking, while a second set of slides remain fixed in the frame, or while the second set of slides is pre-treated by dewaxing or while the second set of slides is treated by staining. Thanks to the slide identification insignia assigned to each slide, the control system may cause each slide or sets of slides to be pre-treated or stained in accordance with the first and/or second treatment protocols. It will hence be appreciated that the apparatus

In one embodiment, the pre-treatment operation is completed in respect of all slides in the frame, before the staining operation is initiated in respect of any one of the slides in the frame. If the slides are subjected to more than one pre-treatment operation, the method and apparatus of the present invention may be configured to complete each pre-treatment operation before the next pre-treatment operation is initiated. In particular, target retrieval is preferably completed in respect of all of the slides in a frame, before staining is initiated. By completing pre-treatment before staining is carried out, a flow of the slides through the apparatus is ensured, which reduces the need for repeated removal of slides from the frame and re-introduction of the slides in the frame. Moreover, the all of the slides in the frame may be subjected to staining simultaneously, while at the same time further slides of another frame are subjected to pre-treatment.

Pre-treatment by drying may be performed prior to pre-treatment by baking if desired.

The slide identification insignias and/or the treatment protocols may be loaded into a memory of the electronic control system through a data input interface before the slides are loaded into the apparatus. For example, an operator may key in or scan in identification insignia and process parameter values of the treatment protocols at a point in time, in which the slides are have not yet been loaded into the apparatus. These steps may e.g. be conducted with the aid of a keyboard, touch screen and/or optical scanner of the apparatus or of an external system, which is configured to pass the information insignia and/or process parameter values for the treatment protocols on to the automated apparatus. In an alternative embodiment, the apparatus assigns the information insignias to the slides, once the frame with the slides has been loaded into the apparatus, and an operator selects or defines the process parameter values of the treatment protocols through a keyboard, touch screen or other interface of the apparatus, which communicates with the memory of the electronic control system.

There may be provided an identification to each frame, allowing the control system of the apparatus to identify frames. For example, each frame may be provided with a bar code or RF tag allowing the apparatus to identify the frame as it approaches the apparatus, or at the time of loading the frame onto the apparatus. The identification insignia of the slides and/or the treatment protocols for the slides may be derivable from or included in the frame identification. Alternatively, the identification insignia of the slides and/or the treatment protocols may be provided via a separate communication channel and associated to the frame and hence the slides of the frame via the frame identification insignia.

Labels may be scanned by the apparatus according to the present invention by means of a reader or scanner at a port of the apparatus. The reader may advantageously operate independently from the staining operations of the apparatus. Accordingly, staining of slides already loaded onto the apparatus can be carried without time loss related to reading or scanning of incoming slides.

The labels may include bar codes, 3D matrices, radio frequency identification (RFID) tags, etc. They may be preprinted or embossed in the slides by a supplier thereof, laser-written onto glass slides, printed on paper-based stickers pre-attached to the slides, or on paper-based stickers manually or automatically attached to the slides as they arrive to the apparatus.

The apparatus of the present invention may comprise or support at least one storage unit for storing a plurality of slides and/or at least one frame with slides. For example, such storage unit may be provided upstream of the stations or downstream of the stations. Alternatively, one or more storage units may be provided upstream of the stations, and one or more further storage units may be provided downstream of the stations. In the present context, the term upstream refers to any location, which the frame and/or slides reaches before it reaches the stations on its way through the apparatus during operation thereof, and the term downstream refers to any location, which the frame and/or slides reaches after it has reached the stations on its way through the apparatus during operation thereof.

The electronic control system of the automated apparatus of the present invention may be configured to cause the stations to operate on a first set of slides held in a first frame, while a second set of slides is stored in one of the storage units. Hence, the storage units may conveniently be used for queuing frames, thereby obviating the need for additional storage facilities. Moreover, the storage units allow frames to be loaded into the apparatus and/or unloaded from the apparatus in an automated manner, whereby the capacity of the apparatus may be used outside of working hours.

The control system may be configured to assign a priority level to each frame and/or to each slide. The priority level may be constant or it may be changed, e.g. by an operator. The priority level may be changed even after the frames and/or slides have been loaded into the apparatus, e.g. by operator input via an adequate communication interface, such as a keyboard or touch screen.

The storage units may be utilized for intermittently storing slides, in case a frame and/or slides with high priority are loaded into the apparatus, or in case the priority of frames and/or slides changes, while the frames are being processed in the apparatus.

The present invention also provides a system for staining a plurality of biological samples comprising an automated apparatus according to the invention and a suitable frame for supporting the slides and holding them in mutually fixed positions.

The treatment protocols may include commands or instructions to offload frames and/or slides and/or to intermittently store them in the at least one storage unit. This may, for example, be desirable if it is intended to have the slides processed externally, e.g. by another apparatus or manually, between pre-treatment or staining operations.

In a third aspect the invention further provides an automated apparatus for staining of a plurality of biological samples arranged on slides, comprising:
a structure for supporting a frame for holding the slides in mutually fixed positions at respective sites;
an electronic control comprising data input structure for receiving a treatment protocol for each of the slides;
a plurality of stations for carrying out pre-treatment and/or staining in accordance with said treatment protocol;
a conveyor system configured to position the frame and the slides relative to the stations in a sequence prescribed by said treatment protocol and in response to control signals provided by the electronic control system;
at least one storage unit for storing a plurality of slides and/or at least said frame,
   wherein the apparatus is configured to store the plurality of slides and/or the frame in the storage unit, while the stations and conveyor system operate to process other slides and/or other frames.

In a fourth aspect, the present invention provides a method for staining of a plurality of biological samples arranged on slides, comprising:
arranging the slides in a frame, in which the slides are held in mutually fixed positions at respective sites;
loading the frame with the slides into an automated staining apparatus comprising a plurality of stations for pre-treatment and staining of the slides;
causing an electronic control system of the staining apparatus to assign a slide identification insignia to each of the slides in the frame;
loading, into said electronic control system, at least one treatment protocol for the slides, wherein the treatment protocol identifies at least one pre-treatment operation and at least one staining operation of a staining process and provides at least one process parameter value of each of said pre-treatment and staining operations;
causing said stations of the automated apparatus to subject each of the slides to said pre-treatment and said staining operation in accordance with said at least one process parameter, whereby the apparatus moves the slides to and from the stations as required by the treatment protocol;
unloading the frame with the slides from the automated staining apparatus with the slides held in mutually fixed positions at respective sites in the frame.

The slides may be removed from the frame while loaded into the apparatus, however an operator of the automated apparatus experiences that the frame is loaded into and offloaded from the apparatus with the slides being held in fixed positions in the frame. The frame may be offloaded from the apparatus after any pre-treatment or staining step. For example, the frame may be offloaded after a first pre-treatment step and loaded onto the apparatus again at a later point in time or even transferred to another apparatus or facility for further processing. Likewise, individual slides of the frame may be removed from the frame at any stage. Removed slides may be placed back into the frame at any stage within the apparatus or at a site outside of the apparatus.

The fourth aspect of the invention also provides an automated apparatus for carrying out the method of the fourth aspect of the invention.

### DETAILED DESCRIPTION OF THE INVENTION

Preferred embodiments of the invention will now be described with reference to the drawings, in which:

FIG. 1 illustrates a top view of an embodiment of an automated apparatus according to the invention;

FIG. 2 illustrates the apparatus of FIG. 1 in a side view;

FIG. 3 illustrates the embodiment of FIGS. 1 and 2 in a top view, marked with areas allowing direct operator access to instruments;

FIGS. 4-6 are simplified sketches of embodiments of an automated staining apparatus according to the present invention;

FIG. 7 is a simplified drawing of an embodiment of an automated staining apparatus;

FIG. 8 illustrates loading, storage and baking modules of an automated staining apparatus according to the present invention;

FIG. 9 shows moving of slide racks between storage and treatment modules in the staining apparatus of FIG. 8;

FIG. 10 shows a line up of treatment modules in the staining apparatus of FIGS. 8 and 9;

FIG. 11 illustrates mechanical movements in dewaxing/dehydration and target retrieval modules and a shared robot arm in the staining apparatus of FIGS. 8-10;

FIG. 12 includes schematic drawings of one embodiment of a target retrieval dip tank with an inserted slide as seen from the side and above. The low volume tank includes a combined fresh and preheated water inlet, overflow and bottom drainage, stirring bar and temperature sensor.

FIG. 13 is a schematic drawing of the fully automatic test set-up fixture, including dip tank, slide, DC motor with permanent magnets, dosing and waste pumps, reservoir for preheating fresh water, a standard circular robot and dispensing pipette.

FIG. 14 is a general flow and control scheme for the fully automatic test set-up fixture, including the dip tank and overflow sensor, pre-heated fresh water reservoir with heater and sensors, dosing pump, fresh water pump, cold water reservoir, 3-way switch and waste pump.

FIG. 15 shows a general procedure scheme used during the temperature ramp up and cool down procedure.

FIG. 16 is a graph illustrating the full target retrieval procedure temperature profile during heat up and cool down. The external temperature is measured on the slide and the internal temperature at the bottom of the dip tank.

FIG. 17 is a schematic drawing of a dip tank assembly of a target retrieval module, illustrating an array of tanks and the low inter tank contact surface. Also, the drawing shows a resting position and wash station for robotic buffer dispensers.

In the following, embodiments of the apparatus according to invention will generally be referred to as a ‘stainer’. The instruments referred to herein generally refer to instruments within the apparatus, such as in particular instruments at the stations of the apparatus for carrying out pre-treatment and/or staining operations. Synonyms for the frame for holding the slides in mutually fixed positions include ‘rack’ and ‘case’. Any slide ‘holding device’ or ‘holder’, ‘tray’ or ‘folder’ may also designate a frame within the meaning of the present invention.

One feature of the present invention is to keep patient cases physically together to the extent possible.

By completely avoiding the need for sorting the slides in each case with respect to pre-treatment protocol, staining protocol, priority or cost optimization, the likelihood of errors may be greatly reduced. Any mix up of slides due to erroneous sorting can result in a wrong staining pattern and thus diagnosis. Correcting the error may not be possible, as the tissue sample may no longer be present, and even if possible the re-run is costly with respect to documentation and disturbed workflows.

The present inventor has also realized that by avoiding the sorting process and keeping the patient cases together, it becomes possible in a rational way to load many cases onto or off the stainer whenever the operator is ready and not only when the instrument has empty processing positions for one or more slides.

By keeping the patient cases physically together, loading and off loading many patient cases for e.g. overnight unattended processing can be carried out without mixing of slides from different cases or patients, with a minimum of manual operations, and at the same time efficiently use the instrument's staining throughput capacity.

Also, the inventor has realized that not all cases have the same priority for processing or need to be processed within the same time to obtain the best and most efficient workflow. By keeping the case physically together and avoiding slide sorting it is possible to more efficiently load high priority cases to the instrument, which pass other cases with a lower priority. It is also possible to change priority several times for the various patient cases onboard the instrument.

The invention allows the use of the most optimal baking, target retrieval and staining procedures for each slide on an automated platform without sacrificing the instrument efficiency.

Also, the instrument can include primary stained slides as a supplement to the advanced stained slides in the same case. Thereby it becomes unnecessary to identify and find previously stained slides and add those to the case before inspection of the case.

In embodiments of the invention, the user-operator interaction is improved in a novel way. The operator's actions are not necessarily determined by the instrument's operation, and the operator is allowed to load and remove patient cases at the most convenient time and not at fixed times governed by the instrument's operation. This improves operator convenience, reduces the fixed time constraints in laboratories' workflow and at the same time makes it possible to utilize the instruments' capacity in the most optimal way; as slides can be automatically processed as soon as the processing modules are available. Thereby, the invention combines the best properties from existing batch operating instruments while also avoiding their drawbacks, including manual sorting and the fixed times for loading/off loading the instrument in order to utilize the instrument's capacity.

It should be understood that preferred embodiments of the present invention strongly support the desired effort to optimize the productivity in the pathology laboratory by e.g. so-called Lean methodology—especially with respect to the physical logistics in the laboratory workflow.

The on-board storage of slide racks before, during and after the pretreatment and staining process and long-term, controlled storage of reagents in the cooled reagent bay are built-in “Point of Use Storage” features as known in Lean optimization of productivity. The staining can proceed without the logistical support at fixed time intervals, which will optimize the productivity.

The operator does not need to move the tools—the reagents—to the instrument from the refrigerator, or remove and replace the item—the slides—immediately from the staining instrument when they are stained.

Other built-in Lean features which concern the logistical support of the instrument include, for example, the no-sorting of slides, the on-board water purification system and the on-board preparation and storage of bulk reagents.

One embodiment of the stainer as shown in FIGS. 1-3, the stainer includes several unit operation modules or sections: (i) Loading and off loading drawers, (ii) slide storage compartments for untreated, partly treated and finished slides at 1 in FIG. 1, (iii) baking section, where the tissue is dried and baked by heated air in a near vertical position, (iv) dewaxing section, where the slides in the rack are treated individually with an organic solvent at near horizontal position, followed by treatment with a water miscible solvent mixture, (v) target retrieval section, with the slides placed in near vertical position and partly submersed into individual dip tanks, which are filled with the relevant target retrieval solution and heated, (vi) staining section where the tissue is treated with a series of reagents while at near horizontal position and washed when the slides are in a near vertical position, (vii) cooled reagent compartment for antibodies, probes, mixed chromogens, enzymes and other staining reagents and (viii) a bulk reagent compartment for waste, dewaxing reagents and washing buffers.

The preferred stainer further includes an overhead robot, e.g. of the gantry type, which grips the slide rack and moves them between the various sections according to the protocol, the desired workflow and their priority.

Also included is a reagent bay and a sip and spit reagent robot from which reagents can be dispensed to the slide during staining, a bulk buffer, reagent and waste container section, connecting fluidics, electronic controls and touch screen monitor.

The microscope slides with the tissue samples are mounted on a rack which holds the slides in the same plane next to each other and with the tissue sample facing the same way. The rack can hold e.g. 12 microscope slides and does not need to be completely filled. Each patient case to be stained is mounted on the same rack. If the cases are small enough, several cases can be mounted on the same rack. The rack is loaded onto the stainer through the loading drawer, which also reads the slide labels. The gantry robot moves the slide racks to the various sections in the stainer. The slides mounted on the rack are placed in the various sections where they can be positioned in the vertical position or lifted to a near horizontal position.

A typical internal transport sequence for one rack may include: (i) loading through the drawer, (ii) baking module, (iii) dewaxing module, (iv) target retrieval module, (v) staining module, (vi) storage compartment, (vii) off loading through drawer.

Another internal transport sequence for one rack may include: (i) loading through the drawer, (ii) storage compartment, (iii) baking module, (iv) dewaxing module, (v) target retrieval module, (vi) staining module, (vii) storage compartment, (viii) off loading through drawer. In this example, the rack is first stored at the storage compartment before being processed and returned to the storage compartment. This is relevant for several racks which are loaded e.g. late in the afternoon and sequentially processed over night. The stained slides are placed in the internal storage compartment before being removed by the operator the next morning.

Yet another internal transport sequence for one rack may include: (i) loading through the drawer, (ii) storage compartment, (iii) baking module, (iv) dewaxing module, (v) storage compartment, (vi) target retrieval module, (vii) staining module, (viii) storage compartment, (ix) off loading through drawer. In this example, the rack is stored in the storage compartment between the different unit operations. This is relevant for a particular rack with a low priority. The high priority racks then have free access to the various sections.

It should be clear that several of the above mentioned stainer sections or other sections can be included or substituted to expand the capability of the stainer, including extra washing station, special H&E staining section, dedicated ISH staining section, dedicated cytology stainer section, cover slipping, drying, image scanning or capture and extra storage compartments.

In an ISH protocol performed off-line in a manual manner, on a different platform or onboard in a dedicated hybridization module, most of the processes, sub-processes and method steps disclosed herein in respect of IHC staining will be identical or similar to those carried out in respect of IHC staining. Internal shuffling of racks and possible shuffling of racks to an off-line process may thus be facilitated.

The frame of the slides may be removed from the apparatus at any stage and reloaded onto the apparatus at a later stage. For example, the frame with the slides, or individual slides, may be taken out for hybridization in a separate stainer configured for hybridization of slides.

The above described stainer can hold many slide racks and patient cases. Some racks are being processed in the baking, dewaxing, target retrieval and staining sections, respectively. Further racks are stored in the storage compartment and in the loading drawer. Therefore, slide racks can be loaded onto the stainer when there is room in the drawer or storage compartment or in the first process sections. Similarly, racks can be removed at anytime through the drawer: Both processed slides from the last staining section, partly processed racks or finished racks from the storage compartments. The operator does not need to empty one or more of the stainer's process sections before loading a new patient case or slide rack into the instrument. Further, the slides do not need to be sorted according to staining protocol, including target retrieval method. Similarly, the slides do not need to be resorted and assembled into the case again, as the case and order of slides is the same at loading and off loading.

By the term “internal storage” is meant the capability to hold slides and slide racks in the instrument prior to and after the treatment processes and not taking up room for or otherwise blocking the processing capability of other slides.

Also, the internal storage capacity includes the full software control of the slides and the ability to automatically move the slides or slide racks to and from the internal storage when most convenient.

It should be understood that by internal storage is included a separate storage compartment, which may be physically outside the stainer instrument or processing modules, but still allow for automatic moving of the slides or racks between the instruments, modules and sections.

The internal storage compartment or compartments can hold the slides or slide racks under controlled conditions, that is heated, cooled, dry or wet, according to the best conditions for the particular slides.

It should be understood that, in embodiments of the present invention, the different cases are separated from each other and are processed nearly independently of each other. New slides or cases can be loaded onto the instrument in one operation and do not demand resorting or rearrangement of other slides in order to optimize the instrument's performance.

Similarly, the slide does not need to be mounted with cover slips, slide tiles or other devices prior to loading on the instrument, nor do such devices need to be removed after off loading.

The reduction of the number of manual handling steps reduces the general human stress of operating the stainer and introduces previously unseen workflow flexibility in the laboratories. This functionality is fundamentally different from the way any other stainers operate.

In summary, due to the design and the internal slide transport between process sections and storage compartments, embodiments of the stainer can (i) store more slides than can be processed simultaneously, (ii) can treat slides on the same rack with different target retrieval and staining protocols, (iii) allow priority slides to pass other slide racks with lower priority, (iv) allow a new priority scheme to take effect on slides which are already loaded or partly processed, and (v) work unattended overnight.

FIG. 4 shows a simplified sketch of an embodiment of an automated staining apparatus with a functional skin, including touch screen (15.1), drawer for slide rack (15.2), three drawers for specific reagent containers (15.3), doors for access to bulk reagents (15.4) and waste containers (15.5) and a pull out table (15.6).

FIG. 5 is a simplified sketch of an embodiment of an automated staining apparatus with a functional skin seen from the front and side, including a 170 cm tall reference person, including touch screen (16.1), pulled out drawer for slide rack (16.2) and specific reagents.

FIG. 6 is a sketch of an embodiment of an automated staining apparatus with a functional skin. To the left with open door to the bulk reagents (17.1) and to the right with the top lid open for access to the robotics during repair and service (17.2).

As schematically illustrated in FIG. 7, an embodiment of an automated staining apparatus comprises several treatment modules and robots, including a drawer (6.1) for loading and off loading racks, an overhead gantry robot (6.2) that can grab, lift, transport, lower and release slide racks into the various positions in the apparatus, a storage room (6.3) for multiple slide racks, a warm air baking and drying module (6.4) harboring more than one slide rack, a dewaxing and rehydration module (6.5), a target retrieval module (6.6) with an array of target retrieval dip tanks, a staining module (6.7) with mixing grid, an overhead x-y-z reagent delivery robot (6.8) with a multidispensing reagent probe and air knife, a reagent bay or module (6.9) harboring multiple specific reagent containers under temperature control and accessible for loading and changing through separate drawers (6.10).

The lower part of the staining apparatus comprises a number of bulk reagent containers (6.11) for wash and target retrieval buffer concentrates, dewaxing, rehydration and dehydration solutions, in addition to waste containers for organic (6.12) and toxic aqueous waste (6.13) and an internal water purification module (6.14) capable of purifying tap water for use in the apparatus. The apparatus has a connection to the general sewage system for the non-toxic aqueous waste. The apparatus has a supporting and stable frame (6.15) mounted with wheels (6.16).

The apparatus can store and process several slide racks at the same time. The gantry robot moves the racks between the treatment, storage and loading modules.

FIG. 8 illustrates loading, storage and baking modules of an embodiment of an automated staining apparatus according to the present invention. The slide rack with up to 12 slides is loaded into the apparatus through a drawer arrangement which also harbors a fast slide label reader (8.1). An overhead gantry robot arm (8.2) grabs, lifts and transports the slide rack (8.3) to the storage or treatment modules.

A storage compartment (8.4) can hold up to 10 slide racks prior to or after the staining process. The storage compartment also acts as a buffer and rack sorting station for the continuous workflow operation during day or night.

A baking module (8.5) can hold up to two racks and uses actively pushed warm and dry air for baking and drying wet formalin fixed paraffin embedded (FFPE) slides.

FIG. 9 shows moving of slide racks between storage and treatment modules in the staining apparatus of FIG. 8. The slide rack is loaded into the stainer through the drawer arrangement (8.1). The overhead gantry robot arm (8.2) grabs and transports the slide rack (8.3) to the storage compartment (8.4) or any of the treatment modules, e.g. the drying and baking module (8.5) or dewaxing and rehydration module (8.6).

FIG. 10 shows a line up of treatment modules in the staining apparatus of FIGS. 8 and 9. The treatment modules are lined-up in a typical procedural order. Slides mounted in racks are moved consecutively from e.g. the storage compartment (8.4) to the drying and baking module (8.5), the dewaxing module (8.6) (here shown with the rack hanging vertically), the target retrieval module (8.7) (here shown without the lid over the individual dip tanks) to the staining module (8.8) with the mixing grids (here shown with the slides in the horizontal position).

A reagent probe (8.9) delivers reagents to the staining module from a cooled reagent storage unit (8.10) with multiple drawers.

The reagent robot arm is mounted on the same rail (8.11), which also holds the gantry robot used for moving the slide rack between the modules.

FIG. 11 illustrates mechanical movements in dewaxing/dehydration and target retrieval modules and a shared robot arm in the staining apparatus of FIGS. 8-10. After drying and baking in the baking module (8.5), the slide rack (8.3) is moved by the gantry robot to the dewaxing and rehydration module and is turned to a near horizontal position.

The module is capable of treating the individual slides with dewaxing, rehydration and dehydration solutions from the reagent probe followed by gentle cleaning by an air knife (8.12) on the robot arm (8.13). The individual slide treatment and single use of reagents prevent any cross-slide tissue migration.

The robot arm (8.13) is shared with the neighboring target retrieval module and where it's probe (8.14) delivers target retrieval buffer concentrates into each of the 12 individual tanks through a hole (8.15) through a lid while the slides in a further rack (8.16) are immersed into each small dip tank, each of which is configured as illustrated in FIG. 12.

The double function of the delivery robot will never conflict as the two actions are never done at the same time during the general procedure. For simplicity, fluidics and air tubing are not shown.

FIG. 12 includes schematic drawings of one embodiment of a target retrieval dip tank with an inserted slide as seen from the side and above. The low volume tank includes a combined fresh and preheated water inlet, overflow and bottom drainage, stirring bar and temperature sensor. As seen in FIG. 12, the slide (1.1) is placed vertically in the middle and each tank has an inlet (1.2) for pre-heated and cold water, an overflow drain (1.3) with an overflow sensor, a bottom drain (1.4) controlled by an valve, a magnetic stirring bar (1.5) controlled by an external DC motor and magnet, a heating foil around the dip tank (not shown) and a temperature sensor (1.6). A fully automatic test set-up fixture was built for evaluating the dip tank's performance, including fluidics handling and temperature.

FIG. 13 is a schematic drawing of the test set-up fixture built on a standard breadboard basis (Thorlabs, BIT Analytical Instruments, Schwalbach, Germany).

In short, the standard (Menzel) microscope slide (2.1) was placed in the slit in the lid (2.2) and partly immersed in the dip tank (2.3). The magnetic stirring bar was placed in the dip tank. Below the dip tank, the DC motor (2.4) (cat no. SFF-030VAV, SGST) with permanent magnets was mounted on a supporting plate (1.5 mm thickness; BS EN 1.4301 stainless steel sheet), together with a dosing pump for delivering warm/cold fresh water to the dip tank and a waste pump (2.6) for emptying the dip tank.

Next to the dip tank assembly a reservoir (2.7) for preheating of fresh water was placed with level sensor, electric heater and thermometer sensor.

Also, a standard circular robot (2.8) (Theta-Z Robotic Arm, cat. no 71905220) and dispensing pipette (2.9) (inner/outer diameter 0.6/1.0 mm) (both from BIT Analytical Instruments), were mounted next to the dip tank for automatic dispensing of liquids directly into the dip tank during tests.

The dip tank was mounted with a thermo sensor (Betatherm NTC thermistor) in the bottom, a self calibrating fluidic sensor at the overflow drain.

The preheated fresh water reservoir, dosing pump (Micro diaphram pump, up to 100 ml/min, NF10 KPDC, KNF), cold water reservoir and a 3-way valve switch (3/2 Valve cat. No. FAS F09055 20-09 from Bürkert) and waste pump were connected with tubing (standard Tygon) as described in the general flow scheme in FIG. 14.

Further, the dip tank was wrapped with a heating foil (Betatherm, 12V/48 W) and additional isolation material to minimize heat loss. The entire test set-up was remotely controlled by a standard general module board, software and a simple user interface (FingerTip Version 3.2 Build 2, all from BIT Analytical Instruments).

Various procedures for dilution, mixing, heating up, cooling down and washing with warm or cold water could be tested with the test set.

In the following examples, various dip tank properties were recorded using the automatic set-up. Where possible, the performance was recorded with a still and video camera (5 MP CSOS digital camera).

All electronic input and output were collected for post analysis, including static analysis.

### Example A

### The Temperature Ramp Up Time, Temperature Stability and Ramp Down Time

In this example, preheated water was pumped into the heated dip tank for a period to reduce the total heating up time before the heating alone heated up the dip tank. Also, during cool down, cold water was pumped into the dip tank to fast reduce the temperature and wash the tank.

FIG. 15 depicts a specific procedure scheme used during the temperature ramp up and cool down procedure.

In short, a) the preheated water reservoir was filled, b) fresh water pump started, c) fill level sensor activated, d) fresh water pump stopped, c) heating of preheated reservoir started, d) temperature sensor at 95° C., e) heating of preheated reservoir stopped, f) 3 way valve switched to open to preheated water reservoir, g) dosing pump started, h) mixer started, i) temperature measurement started, j) heating in dip tank (foil) started, k) overflow sensor activated, l) dosing pump stopped after 30 seconds, m) waste pump started for 200 milliseconds, n) dip tank heating to 98.5° C., on/off according to control algorithm, o) incubation for 25 minutes, p) 3 way valve switched to open to cold water reservoir, q) dosing pump started, r) overflow sensor activated, a) dosing pump stopped after 60 seconds, t) waste pump started for 200 milliseconds, u) stirring stopped, x) heaters turned off.

FIG. 16 is a graph illustrating the full target retrieval procedure temperature profile. The external temperature was measured with a sensor on the slide surface and the internal temperature at the bottom of the dip tank. The temperature curves are parallel.

The external temperature was verified against a standard. The internal temperature was with an uncorrected offset.

As illustrated in the graph, the TR procedure is easily followed by the temperature curve. The process goes through 6 phases:
1. Starting conditions at 23° C.
2. Heating I: Preheated water was flushing into the dip tank, while stirring, until 63° C.
3. Heating II: The inlet flow stopped, the level adjusted, only heating from the heating foil, until 98° C.
4. Incubation phase with constant temperature at 98° C. for more than 20 minutes
5. Cooling down (and washing) by flushing with cold water, until temperature below 45° C.
6. Stopped, with microscope slide still in cold water and with no stirring. Slide ready to be moved to staining module.

By analyzing the recorded data, the average temperature over 25 minutes was calculated to 98.5° C. with a standard deviation of 0.22° C.

Also, using the cold-water-flush method, the temperature could be lowered from 98.5° C. to below 45° C. in less than 18 seconds.

In summary, using a warm-water-flush method, heating foil and stirring in the dip tank, the temperature could be raised from 23° C. to 98° C. in 232 seconds, or less than 4 minutes.

The process parameters, including preheating reservoir temperature, preheated water volume and temperature-time-power algorithm for controlling the heating foil, have been mapped for further optimization.

Also, an error correcting scheme has been constructed based on the feed back information from the temperature-time curve.

### Example B

### Mixing and Washing Efficiency

The mixing efficiency was estimated using dyes in the same general set-up as in example A, except for no heating and without lid.

In short, a strongly colored dye solution was prepared by dissolving 30 mg of Thymol Blue (thymolsulphonephthalein, cas no 76-61-9, Sigma-Aldrich, cat. No 114545-5G) in 50 ml demineralized water. 5 mg of NaOH pellets (Fluka, cat. No. 71691) were added to dissolve the Thymol Blue and homogenized by a vortex mixer (IKA: MS 3 digital) for 10 minutes.

The dip tank was filled with 24 ml demineralized water using the standard dosing pump method, the mixing was stopped and 100 μl dye solution dispensed by the automatic robot. The strong blue dye drops were clearly seen in the dip tank.

The mixing was started and the mixing pattern observed and a video recorded. The experiment was repeated both with slide and without slide.

Mixing was complete within 3 seconds, both with and without a slide in the dip tank. The liquid in the dip tank became light bluish without any visibly inhomogeneous areas.

After realizing the homogeneous mixture in the dip tank, the washing process efficiency was estimated.

The mixing was continued and the dosing pump was started and excess water ran into the overflow drain.

The dye was clearly washed out and the liquid was colorless with no traces of blue color against the white dip tank interior.

Without slide, a complete washing of the dip tank was realized within 30 seconds, according to the time sequence of the photos taken from the video sequence.

With a slide inserted in the dip tank, a complete washing of the dip tank was realized within 20 seconds or less. The inserted slide seems to increase the speed of substituting the colored water with clean colorless water. A closer study of the video sequence indicates a split stream mixing mechanism around the slide in addition to the efficient circular mixing movement from the mixing bar in the bottom.

In conclusion, diluting and mixing of a small dispensed liquid volume into the larger volume in the dip tank was completed within 3 seconds, Also, complete washing of the dip tank could be realized after less than 30 seconds.

### Example C

### Carry-Over Measurements

The carry-over was quantified in experiments using a typical protocol for change of buffer. As the pH is the most critical parameter in the target retrieval procedure, the carry-over was quantitatively measured as the change in pH when changing the type of target retrieval buffer system in the dip tank.

The general set-up was the same as described in Example A, except that no heating or cooling protocol steps were included in this experiment, all in order to limit any uncontrolled effects from the special prototype polyamid material and potential diffusion of carbon dioxide to and from the atmosphere.

Two different target retrieval buffer concentrates were used:

250 μl low pH target retrieval buffer concentrate (PT Module Buffer 1 Thermo Scientific cat. no TA-125-PM1X; 100× citrate buffer, pH=6), and 250 μl high pH target retrieval buffer concentrate (PT Module Buffer 4, Thermo Scientific cat no. TA-125-PM4X; 100 mM Tris/1 mM EDTA, 100× citrate buffer, pH=9).

During the experiment, the concentrates were diluted in demineralized water in the 24 ml dip tank volume, according to the recommendation by the manufacturer.

A calibrated pH-meter (S20 SevenEasy, Mettler Toledo) was used to perform the pH measurements.

The testing cycle was the following:

First the fresh water reservoir was filled, b) fresh water pump started, c) fill level sensor activated, d) fresh water pump stopped, c) valve switched open to water reservoir.

Subsequently, the dip tank was operated: d) dosing pump started, e) overflow sensor activated, f) dosing pump stopped, g) waste pump started for 200 milliseconds, h) 250 μl high target retrieval buffer concentrate added by the pipette, I) mixer started, j) after incubation for 20 minutes, pH was measured, k) dosing pump started for 30 seconds, m) waste pump started for 20 seconds and n) stirring stopped.

This cycle was repeated first with high pH TR buffer, three times with low pH TR buffer and finally with the high pH TR buffer.

The table below summarizes the cycles and the pH measurement.

| | Buffer #1, | | |
|---|---|---|---|
| Cycle no | pH units | Buffer #2, pH units | Change in pH |
| #1—pH normal | | 8.28 | |
| #2—pH carry over | 6.67 | | |
| #3—pH nominal | 6.56 | | |
| #4—pH nominal | 6.54 | | (#4-#2): +0.13 |
| #5—pH carry-over | | 8.30 | (#5-#1): +0.02 |

The above testing procedure was a worst case scenario, as the TR buffer was changed from high to low and back to high pH again and no separate washing procedure introduced. Also, the surface of the nylon rapid prototype dip tank was rough and had not been polished.

In conclusion, the pH carry-over was less than 0.13 (from high to low: 0.13 and low to high: 0.02), which is less than what is recommended by the TR buffer manufacturer (0.15) as the maximum deviation when making the TR buffer directly.

### Example D

### Test of Foaming

Foaming of reagents during the target retrieval procedure is a potential disturbing phenomenon which could block liquid sensors or cause staining artifacts.

The TR buffers both contain detergents and mixing could potentially drag air into the solution or promote foaming.

The test set-up was as in example no. 2 and 5. Four different experiments were conducted for quantifying foaming phenomena during constant mixing: Using the high pH TR (pH 9) buffer for 20 minutes at room temperature and at 98.5° C. and the low pH TR buffer (pH 6) for 20 minutes at room temperature and at 98.5° C.

The dip tank was observed and a video recorded. When dispensing of the concentrate, a few bubbles were observed, but they vanished within seconds of mixing.

No persistent foam was observed after 20 minutes at 98.5° C. and at full speed mixing using either the low pH citrate or high pH TRIS TR buffers

In conclusion, no foaming was observed in the worst case experiment combining vigorous mixing, heating and using TR buffers known to easily form foam.

### Example E

### Measurement of Evaporation

The degree of evaporation was quantified in an experimental set-up similar to example no. 2 and 5 with vigorous mixing for 20 minutes and at 98.5° C. The experiment was done with lid—but without a slide inserted in the dip tank.

After 20 minutes, the liquid was removed and weighted. Less than 1.5 ml out of the 24 ml in the dip tank was evaporated.

As a control experiment, the same experiment was done without the lid and slide. About 5-6 ml of the liquid had evaporated after 20 minutes.

In conclusion, without lid, evaporation was significant, indicating that the lid has a significant impact on the reflux of condensed water into the dip tank.

With the lid mounted, no significant evaporation was observed in the experiment at near boiling for 20 minutes and with no slide in the slit in the lid. The cold lid reflux design worked.

End of example E.

FIG. 17 is a schematic drawing of a dip tank assembly of a target retrieval module, illustrating an array of tanks and the low inter tank contact surface. Also, the drawing shows a resting position and wash station for robotic buffer dispensers. A plurality of target retrieval dip tanks of the type depicted in FIG. 12 are placed in an array as illustrated in FIG. 17. The tanks (8.1) are placed close together, but also have a minimum of physical contact due to the trapezoid shape. An isolation material between the tanks prevents temperature cross talk. The array also includes a resting position and washing station (8.2) for the target retrieval probes. After treatment, the slide rack is moved to the next treatment module by the gantry robot.

General aspects of pre-treatment and staining applicable to the present invention will now be described.

Enzymes used for IHC staining techniques include horseradish peroxidase (HRP) or alkaline phosphatase (AP). Typical chromogens capable of generating HRP catalyzed stains include diaminobenzidine (DAB), 3-Amino-9-ethylcarbazol, (AEC), 4-Chloro-I-naphthol (4-CN), Naphthol AS-TR phosphate, 5-bromo-4-chloro-3-indolyl phosphate (BCIP) or p-nitrophenylphosphate (pNPP). For AP enzyme, the chromogens include (5-bromo-4-chloro-3-indolyl phosphate and nitro blue tetrazolium (BCIP/NBT), Liquid Permanent Red (LPR), fast red, fast blue, permanent red and New Fucsin. Numerous one or multi component chromogens are commercially available to create localized, colored and permanent or soluble stains.

The chromogen stains can be enhanced to change color or intensity. Examples include the use of copper or osmium darkening of DAB stains.

The staining protocol may include a number of blocking solutions for e.g. endogenous enzyme activity or various cross reactivities.

Endogenous peroxidase activity can be blocked with weak peroxide solution in methanol and alkaline phosphatase blocker includes levamisole or hydrochloric acid.

If biotin-streptavidine or biotin/avidine visualization systems are used, endogenous avidin binding activity is removed with, for example, free avidine and biotin in sequential steps or with acidic and oxidizing solutions prior to the application of the visualization system and staining.

Also, cross species reactivity in especially multi target staining or animal research staining is sought minimized by blocking with various sera, purified antibodies or region specific antibodies.

Definitions of common terms in IHC may be found in Harlow & Lane, Antibodies, A Laboratory Manual, Cold Spring Harbor Publications, New York (1988).

Another advanced staining method called in situ hybridization (ISH) or fluorescent in situ hybridization (FISH) uses molecular probes like for example DNA, RNA, LNA, PNA or similar specific compounds for detecting and staining genetic material in the sample. The methods of staining resemble that of traditional IHC with precipitating chromogens (CISH) or use fluorescent labels like for example fluorescein, coumarins, Cy5, Cy7, Alexa dyes, AMCA, Cascade Blue, Green fluorescent protein (GFP), gold or particles. Examples include the staining and detection of overexpressed human epidermal growth factor receptor 2 (HER2; ERBB2) gene, located on chromosome 17 in breast cancers or the detection of Epstein-Barr virus (EBV) in for example Hodgkin lymphoma using labelled RNA probes.

An introduction to staining methods, including chromogenic and fluorescent stains, direct and indirect and polymeric visualization systems and blocking strategies can be found in the IHC Staining Methods (5. ed., Dako A/S, Glostrup, Denmark).

Other advanced staining methods include special stains or histochemical stains and employ chemical reactions to color various chemical functionalities and structures. Examples include Grocott's Methenamine Silver staining of tissue containing fungi or the Periodic Acid Schiff (PAS) staining of neutral polysaccharide or glycogen in liver, kidney or muscle tissue.

The special stains methodology is sometimes combined with the antibody or in situ hybridization staining methods to develop new staining patterns. Examples include the use of silver enhanced ISH (SISH) stains, detectable micro particles like Q-Dots and various signal amplification techniques like Tyramide signal amplification (TSA, DuPont NEN Life Science, Boston, Ma-USA) and catalyzed signal amplification (CSA)

IHC, ISH or SS stains can be supplemented with a general stain to highlight morphological features. The most common so-called counterstaining includes H&E stains.

It should be understood that the term “staining” can refer to both the procedure using target specific reagents, but also in the literature often refers to the entire procedure from baking to counter staining.

The advanced staining methods can be combined on each slide with multiple target specific antibodies, molecular probes, different chromogenic and fluorescent dyes and a general H&E stain to give the most diagnostic information from each sample.

After staining and optionally counterstaining, the slides are treated with a solution or solvent compatible with the subsequent coverslip media or glue. Depending on the chromogen used or the coverslip method, the tissue is treated with one or a series of organic or aqueous solutions. In order to preserve the staining intensity, quality and tissue morphology and integrity, the slides are coverslipped a short time after finishing.

The current stainer is capable of such finishing or clearing of the slides immediately after the staining process and delivering the slide rack to the operator through the loading port.

Alternatively, the finishing or clearing step can be delayed and done in the staining module or in the dewaxing module after a period in the storage compartment. This is advantageous, if several racks of slides are to be off loaded over a short period after e.g. an overnight run. All the slide racks are then immediately ready for automatic or manual coverslipping according to the protocol.

The term “sample” refers to any biological sample including biomolecules (such as proteins, peptides, nucleic acids, lipids, carbohydrates and combinations thereof) that is obtained from or includes any organism including bacteria or viruses. Biological samples include tissue samples such as biopsied tissue (for example, obtained by a surgical biopsy, a needle biopsy or fine needle aspirate (FNA)), cell samples (for example, cytological smears such as Papanicolaou smear (also called Pap smear), blood smears or samples of cells obtained by micro dissection), samples of whole organisms (such as samples of yeast or bacteria), cells and cultured cells or cell fractions, fragments or organelles (such as obtained by lysing cells and separating their components by centrifugation or otherwise). Other examples of biological samples include blood, serum, urine, semen, fecal matter, cerebrospinal fluid, interstitial fluid, mucous, tears, sweat, pus, nipple aspirates, milk, vaginal fluid, saliva, swabs, buccal swabs, or any material containing biomolecules derived. Samples also include reference or calibration material from, for example, cell cultures or of non-biological or artificial origin.

The term “sample” also refers to any of the states the material can be in during the treatment and staining. Including samples in the form of fresh, frozen, fixed, embedded, partly stained or stained samples.

The term “slide” refers to any substrate (such as glass, quartz, plastic or silicon) of any dimensions on which a biological sample is placed for analysis, and more particularly to a “microscope slide” such as a standard 3″×1″ glass slide or a standard 75×25 mm glass slide. The slide can be silanizied, coated with polylysine, epoxy or isothiocyanate groups or otherwise treated to promote covalent or non-covalent binding of the sample to the surface.

Examples of biological samples that can be placed on a slide include a cytological smear, a thin tissue section (such as from a biopsy), or alternatively, can be an array of biological samples, for example a tissue array, a DNA array, an RNA array, a protein array, or any combination thereof. Thus, in one embodiment, tissue sections, DNA samples, RNA samples, and/or proteins are placed on a slide at particular locations. The term slide includes both plain slides and slides with mounted sample.

In the following, the preparation of the sample prior to the sectioning and mounting on the microscope slide is briefly described, as this is particular relevant for the current invention. In particular the target retrieval and specific staining method by which the sample has been prepared has a strong influence on the best method used for the analysis, As described previously, the tissue is often fixed and embedded and cast into blocks before sectioning.

Tissues may be fixed by either perfusion with or submersion in a fixative, such as an aldehyde (such as formaldehyde, paraformaldehyde, glutaraldehyde, and the like). The most commonly used fixative in preparing samples for IHC is formaldehyde, generally in the form of a formalin solution (4% formaldehyde in a buffer solution, referred to as 10% buffered formalin).

Other fixatives include oxidizing agents (for example, metallic ions and complexes, such as osmium tetroxide and chromic acid), protein-denaturing agents (for example, acetic acid, methanol, and ethanol), fixatives of unknown mechanism (for example, methanol, ethanol, propanol, mercuric chloride, acetone, and picric acid), combination reagents (for example, Camoy's fixative, methacam, Bouin's fluid, B5 fixative, Rossman's fluid, and Gendre's fluid), microwaves, and miscellaneous (for example, excluded volume fixation and vapor fixation). Additives may also be included in the fixative, such as buffers, alcohols, detergents, tannic acid, phenol, metal salts (for example, zinc chloride, zinc sulfate, lanthanum and lithium salts).

Paraffin is used in the histochemical art for embedding or otherwise supporting biological samples for histological or other analyses. When casted in blocks, the sectioning of the sample is possible. Examples of embedding medium include, but are not limited to, wax, paraffin, paramat, paraplats, peel away paraffin, tissue freezing medium, cryonic gel, OCT™ (“Optimum Cutting Temperature”) embedding compound, Polyfin™, and polyester wax.

The combination of formalin fixed and parafin embedded tissue is referred to as FFPE tissues.

The FFPE tissue blocks containing the material to be analyzed are first trimmed and then cut into thin section on a manual or automatic microtome. The 2-10 micrometer thin sections are collected on a water bath and placed on labeled microscope slides. The slides are used for the primary or advanced staining procedures or intermediately stored.

In the advanced staining procedure, including IHC, the first procedural steps conducted on the FFPE tissue on slides are baking and dewaxing of the tissue and for most tissues to be stained by the IHC or ISH methods, a target retrieval step, also referred to as epitope retrieval, target antigen retrieval or target unmasking.

In general, for FFPE tissue, the target retrieval process breaks the protein cross-links caused by the formalin fixation process and unmasks the antigens and epitopes in formalin-fixed and paraffin embedded tissue sections, thus enhancing the staining intensity of the applied antibodies or molecular probes.

Unfortunately, not all targets can be target retrieved with the same protocol. Also, different levels of fixation or different fixation methods and fixatives command different target retrieval procedures in order to facilitate specific and efficient staining.

The most common target retrieval method is treatment of the sample in a suitable buffer at elevated temperature, typically 90-105° C. for 10-60 minutes. The process is referred to as heat induced epitope retrieval or HIER or heat induced antigen retrieval (HIAR).

A majority of epitopes are retrieved with HIER treatment at high pH (e.g. pH 9, TRIS, EDTA). In general, the high pH HIER seems to give a subsequent higher staining intensity than for e.g. low pH methods, but sometimes at the cost of changes in cell and tissue morphology.

Numerous solution mixtures can be used for HIER, including Tris(hydroxymethyl)aminomethane (TRIS), urea, EDTA, citrate and saline buffers. Citrate pH 6 and TRIS with EDTA at pH 9 are the most common. Reagents for controlling the pH of the solution can be chosen from a wide range of buffers such as TRIS, citrate, phosphate, glycine or Good buffers, such as BES, BICINE, CAPS, EPPS, HEPES, MES, MOPS, PIPES, TAPS, TES or TRICINE, metal chelating compounds like EDTA or EGTA, microbial preservatives like azide, glycerol, glycols, peg, polar organic solvents or ionic or non-ionic surfactants like NP40 or Tween20/80. Other HIER systems use solutions of Citraconic anhydride (CCA) or pure distilled water.

Some epitopes are best retrieved at low pH (e.g. citrate pH 6). Examples include Prion Protein, clone 3F4, epithelial related antigen, clone MOC-31 and to some degree also e.g., epithelial antigen, clone Ber-EP4; CD31, clone JC/70A; glycoprotein 200, clone 66.4.C2; epithelial related antigen, clone MOC-31.

Other epitopes are best retrieved by proteolytic enzyme digestion. This is done at near room temperature. Pronase, pepsin and trypsin are the enzymes most frequently used. Pepsin seems particularly useful for extracellular epitopes (for example collagen IV, laminin). Other examples of antibodies for which the epitopes are preferably retrieved using proteolysis include cytokeratin (CK) 8/7, clone Cam 5.2; prostate specific antigen, clone 28/A4; and collagen IV, clone CIV 22.

A few epitopes are best retrieved by a procedure including both proteolytic enzyme digestion and HIER. Examples include Collagen VI, VI-26, clone VI-26, Calpain clone 12A2 and Spectrin, clone R8C2/3D5.

Some epitopes are apparently demasked equally well by HIER and proteolysis. Important differences may exist, however. Thus, using either of the methods 5-100beta protein may be demasked with the same efficiency in nerves, whereas only HIER allows proper detection of S-100beta in some epithelia and striated muscle. Cytokeratin 20, clone Ks20.8, gives a false positive staining in some epithelia after proteolysis but not after HIER. In some cases, where both heat and proteolysis provides good epitope retrieval, the latter method may require a higher Ab concentration to give an optimal result.

Some epitopes in FFPE tissue can be stained without target retrieval or with a much milder treatment than others, resulting in a better preserved morphology. Examples include Glucagon, clone A0565 and Growth hormone, clone MUO28-UC.

Updated lists of epitopes, antibody clones and best practice target retrieval procedures are available from IHC quality and standardization organizations, such as Nordic Immunohistrochemical Quality Control (NordicQC), College of American Pathologists (CAP) and United Kingdom National External Quality Assessment Service (UK-NEQAS)

Frozen tissues or cryo samples are normally not target retrieved by HIER, as they are not covalently fixed or only slightly fixed and therefore risk disintegrating and losing the morphology.

HIER can be obtained by many methods by heating the sample on the slide in a target retrieval buffer. For example while the slide is in a horizontal position, vertically in dip tanks at atmospheric pressure, in microwave ovens or in pressure cookers. The efficiency of HIER is a function of temperature, time, pH and chemical composition of the buffer. Temperature and time are inversely related: 120° C. in a pressure cooker for 5-10 min. roughly corresponds to 100° C. in a microwave oven for 20 min. or 60° C. in an incubator for 24 hours. High temperature or prolonged heating can, however, cause damage to the morphology, especially if the tissue is weakly formaldehyde fixed or partly detachment of especially fatty tissue types from the microscope slide.

A systematic IHC diagnosis of a tissue sample uses the staining pattern of different target specific markers on several slides organized in so-called antibody panels. Positive or negative staining patterns for each antibody are used in diagnostic algorithms to extract the diagnostic result based on experience and statistics. Algorithms are used, for example, for search of the primary cancer site, to rule out non-carcinoma, and for tumour sub classification. Panels are organized in groups, for example, identifying tumours of unknown origin, or differentiating haematolymphoid and non-haematolymphoid neoplasms. The panels can be organized in several smaller rounds of analysis, making the classification narrower for each round of analysis. Alternatively, the panel can be large enough to give the diagnosis in the first round.

An example of a simple diagnostic algorithm of a cancer of unknown type could be the use of a panel of five different antibodies (e.g. Vimentin, Desmin, S 100/HMB45/MART-1, LCA, Pan Kreatin). A positive or negative staining pattern for each antibody is combined in the case for differentiating between carcinoma, lymphoma, melanoma or sarcoma. Another antibody panel (e.g. cytokeratin 7, cytokeratin 20, CEA, PAP and PSA) can be used to differentiate between bladder and prostate cancer. Other panels (p63, EpCam, ATM and others) can then differentiate between a prostate cancer and benign prostatic hyperplasia condition.

Typically, the antibody panels consist of 4-10 different antibodies and the diagnostic information is extracted from the inspection of all the slides in each case.

The patient case is assembled during cutting of one or several blocks on the microtome. Cut sections of tissue from the same patient are mounted on a set of microscope slides, possibly together with relevant reference tissues, including positive and negative controls. This set of slides is called a “patient case” or just a “case”. Each case is typically from 4 to 12 slides, depending on the suspected diagnosis and the antibody panels used. Each slide can be mounted with more than one tissue section from the same patient or cell or tissue reference block. The reference tissue or cells can originate from another patient or source. Yet, the reference is part of the case and it is also examined in the context of the particular case.

As described above, the staining protocols use single antibodies or panels of different antibodies for identifying specific proteins or structures in the tissue. The pathologist, possibly supported by an image analysis system, inspects the staining pattern and morphology. It should be understood that the diagnosis is most often based on the visual evaluation of the whole patient case and not merely individual slides.

Some cases require high priority and shorter process time, for example if the patient is still under operation or awaits critical medical decisions. Other cases have in comparison a lower priority due to medical or cost reasons or because the case waits for other tests or examination to be conducted before the complete diagnosis can be constructed.

Also, during the working day tissue sections are sometimes cut from the paraffin blocks on the microtome at fixed time periods and final slides examined at fixed time periods due to e.g. the availability of the staff in the laboratory or at remote locations.

The workflow in the laboratory is therefore not linear with respect to all patient cases. Some patient cases are processed a soon as possible, whereas others on purpose are delayed or withheld in the process workflow.

Some analyses include several analytical rounds using different antibody panels, resulting in multiple cases to be stained. Consequently, the turn around time for each IHC staining is important and a major concern in the laboratories.

The staining protocols are not the same for all the samples in a case. Different pre-treatment protocols are used, most notably for the target retrieval process. Also, the staining protocol uses different blocking reagents, primary reagents and even different visualization systems.

As the staining protocols are not the same for all slides, the process time may not be the same for all slides in a particular case.

1. A method for staining of a plurality of biological samples arranged on a plurality of slides, comprising:
(a) arranging the slides in a frame to form a case, in which the plurality of slides are held in mutually fixed positions at respective sites in the frame;
(b) loading the case into an automated staining apparatus, said automated staining apparatus comprising; a processing section including a plurality of stations for pre-treatment and staining of the slides, and a storage section for storing the case when the case is outside the processing section;
(c) causing an electronic control system, which controls operation of the staining apparatus, to assign a slide identifier to each of the slides in the case;
(d) loading, into said electronic control system, a first treatment protocol for at least one of the slides within the case and a second treatment protocol for at least another one of the slides within the case, wherein each treatment protocol identifies at least one pre-treatment operation and at least one staining operation of a staining process and provides at least one process parameter value of each of said pre-treatment and staining operations, and wherein at least one process parameter value of the first treatment protocol is different from at least one process parameter value of the second treatment protocol;
(e) causing said stations of the automated apparatus to:
subject each of the slides in the case to said pre-treatment and said staining operation in accordance with said at least one process parameter, the apparatus carrying out pre-treatment and optionally staining differently in respect of at least two of the slides within the case and moves the case to and from the stations as required by the treatment protocols; wherein the step of subjecting each of the slides to said pre-treatment comprises subjecting the slides to target retrieval operations carried out in target retrieval units, in which target retrieval is carried out while each target retrieval unit accommodates one single slide only, so as to individually control the target retrieval operations in respect of each one of the slides;
(f) unloading the case from the processing section of the automated staining apparatus;
(g) storing the case in the storage section of the automated apparatus at a point in time, which occurs before or after the electronic control system has assigned a slide identifier to each of the slides in the case and:
before the case is loaded into the processing section of the automated staining apparatus; or
after completion of at least one of said pre-treatment and said staining operations, but before completion of a subsequent one of said pre-treatment and said staining operations; or
after completion of said staining operations, but before completion of a subsequent post-staining operation; or
after completion of all of said pre-treatment, said staining and said post-staining operations;
wherein in steps (b) through (g) the slides remain secured to the frame at all times from a first point in time, when the case is being loaded into the automated staining apparatus, until a second later point in time, when the case has been removed from the automated staining apparatus.

2. The method according to claim 1, wherein:
step (a) includes arranging a plurality of slides into a plurality of frames to form a plurality of cases, each case holding a plurality of slides in mutually fixed positions at respective sites in the frame.

3. The method according to claim 2, wherein step (b) includes loading of at least two of the plurality of cases from the storage section to the processing section of the automated apparatus, and wherein steps (c), (d) and (e) comprise simultaneously processing of said at least two cases at respective stations within the processing section of the automated apparatus.

4. The method according to claim 3, wherein one single case at a time is being processed at each of said stations within the processing section of said automated apparatus.

5. The method according to claim 2, wherein at least a first one of said cases is being retained in the storage section of the automated apparatus, while at least a second one of said cases is being processed in the processing section of the automated apparatus.

6. The method according to claim 2, wherein:
said electronic control system of the automated staining apparatus stores a priority schedule for pre-treatment and staining of the cases;
the plurality of cases are subjected to pre-treatment and staining according to said priority schedule; and wherein
said automated staining apparatus comprises a communication interface allowing changes to the priority schedule, while the plurality of cases are within the apparatus;
the method further comprising, in the event of a change to the priority schedule:
at step (g): intermittently storing at least a first one of the cases at the storage section before processing of that case at the pre-treatment and staining stations has been completed, or before processing of that case at a post-staining station has been completed;
processing, at said stations for pre-treatment, staining and/or post-staining, at least a second one of the cases, which has received higher priority than the first case, while the first case remains stored at the storage section; and
reloading the first case from the storage section to the processing section of the automated staining apparatus upon completion of processing of the second case.

7. The method according to claim 6, wherein, subsequent to said step of reloading, the first case is being processed at one of said stations, while the second case is simultaneously being processed at a second one of said stations.

8. A method for staining of a plurality of biological samples arranged on slides, comprising:
arranging the slides in a frame, in which the slides are held in mutually fixed positions at respective sites;
loading the frame with the slides into an automated staining apparatus comprising a plurality of stations for pre-treatment and staining of the slides;
causing an electronic control system of the staining apparatus to assign a slide identifier to each of the slides in the frame;
loading, into said electronic control system, a first treatment protocol for at least one of the slides and a second treatment protocol for at least another one of the slides, wherein each treatment protocol identifies at least one pre-treatment operation and at least one staining operation of a staining process and provides at least one process parameter value of each of said pre-treatment and staining operations, and wherein at least one process parameter value of the first treatment protocol is different from at least one process parameter value of the second treatment protocol;
causing said stations of the automated apparatus to subject each of the slides to said pre-treatment and said staining operation in accordance with said at least one process parameter, whereby the apparatus carries out pre-treatment and/or staining differently in respect of at least two of the slides and moves the slides to and from the stations as required by the treatment protocols; and
unloading the frame with the slides from the automated staining apparatus.

9. The method according to claim 1, wherein the slide identifier and treatment protocols are loaded into the electronic control system through a data input interface before the slides are loaded into the apparatus.

10. The method according to claim 1, wherein the pre-treatment operation is completed in respect of all slides, before said staining operation is initiated in respect of any one of the slides in the frame or case.

11. The method according to claim 1, wherein the stations are stationary within the apparatus, and wherein the frame is positioned relative to the stations by movement of the frame.

12. The method according to claim 1, wherein said pre-treatment operations are selected from: baking, dewaxing, and target retrieval.

13. An automated apparatus for staining of a plurality of biological samples arranged on slides, comprising:
a structure for supporting a frame for holding the slides in mutually fixed positions at respective sites;
an electronic control system configured to (i) assign a site identifier to each of the sites, (ii) assign a slide identifier to each of the slides, and (iii) associate each of the slide identifiers with the site identifier of the site holding the slide; the electronic control system further comprising data input structure for receiving a first treatment protocol for at least one of the slides and a second treatment protocol for at least another one of the slides, the treatment protocol identifying at least one pre-treatment operation and at least one staining operation of a staining process and providing at least one process parameter value of each of said pre-treatment and staining operations, wherein at least one process parameter value of the first treatment protocol is different from at least one process parameter value of the second treatment protocol;
a plurality of stations, each station comprising structure for carrying out at least one of said pre-treatment and staining operations, respectively, and each station being configured to receive control signals from said electronic control system, so as to perform the pre-treatment and staining operations of each of the slides in accordance with the treatment protocol, whereby the apparatus carries pre-treatment and/or staining out differently in respect of at least two of the slides; and
a conveyor system configured to position the frame and the slides relative to the stations in a sequence prescribed by said treatment protocol and in response to control signals provided by the electronic control system.

14. An automated apparatus for staining of biological samples arranged on a plurality of slides, comprising:
(a) a structure for supporting a frame for holding the slides in mutually fixed positions at respective sites, wherein the frame with the slides forms a case;
(b) a processing section including a plurality of stations for pre-treatment and staining of the slides;
(c) an electronic control system configured to control operation of the staining apparatus and to assign a slide identifier to each of the slides in the case;
(d) an electronic memory operatively associated with the electronic control system comprising, the electronic memory storing a first treatment protocol for at least one of the slides within the case and a second treatment protocol for at least another one of the slides within the case, wherein each treatment protocol identifies at least one pre-treatment operation and at least one staining operation of a staining process and provides at least one process parameter value of each of said pre-treatment and staining operations, and wherein at least one process parameter value of the first treatment protocol is different from at least one process parameter value of the second treatment protocol;
(e) a plurality of target retrieval units for carrying out target retrieval in respect of each of the slides, each target retrieval unit being configured to accommodate one single slide only at a time; said control system and target retrieval units being configured to individually control the target retrieval operations in respect of each one of the slides; said stations of the automated apparatus being configured to subject each of the slides in the case to said pre-treatment and said staining operation in accordance with said at least one process parameter, so as to allow the apparatus to carry out pre-treatment and optionally staining differently in respect of at least two of the slides within the case and to cause the case to be moved to and from the stations as required by the treatment protocols;
(f) structure for allowing the case to be unloaded from the processing section of the automated staining apparatus;
(g) a storage section for storing the case when the case is outside the processing section, the control system being configured to store the case in the storage section of the automated apparatus at a point in time, which occurs before or after the electronic control system has assigned a slide identifier to each of the slides in the case and:
before the case is loaded into the processing section of the automated staining apparatus; or
after completion of at least one of said pre-treatment and said staining operations, but before completion of a subsequent one of said pre-treatment and said staining operations; or
after completion of said staining operations, but before completion of a subsequent post-staining operation; or
after completion of all of said pre-treatment, said staining and said post-staining operations;
wherein the apparatus is configured to handle the case with the slides remain secured to the frame at all times from a first point in time, when the case is being loaded into the automated staining apparatus, until a second later point in time, when the case is unloaded from the automated staining apparatus.

15. The apparatus according to claim 13, comprising a housing accommodating said stations, said housing further accommodating at least one storage unit for storing a plurality of slides and/or at least said frame.

16. The apparatus according to claim 15, wherein the at least one storage unit comprises a first storage unit upstream of the stations, and a second storage unit downstream of the stations.

17. A system for staining a plurality of biological samples comprising an automated apparatus and at least one frame according to claim 15.

18. The system according to claim 17, wherein:
the at least one frame comprises a plurality of frames;
the apparatus comprises the at least one storage unit; and
the electronic control system is configured to cause the stations to operate on a first set of slides held in a first frame, while a second set of slides is stored in one of said storage units.

19. The apparatus according to claim 14, comprising a housing accommodating said stations, said housing further accommodating at least one storage unit for storing a plurality of slides and/or at least said frame.

20. The apparatus according to claim 19, wherein the at least one storage unit comprises a first storage unit upstream of the stations, and a second storage unit downstream of the stations.

21. A system for staining a plurality of biological samples comprising an automated apparatus and at least one frame according to claim 19.

22. The system according to claim 21, wherein:
the at least one frame comprises a plurality of frames;
the apparatus comprises the at least one storage unit; and
the electronic control system is configured to cause the stations to operate on a first set of slides held in a first frame, while a second set of slides is stored in one of said storage units.

23. The method according to claim 8, wherein the slide identifier and treatment protocols are loaded into the electronic control system through a data input interface before the slides are loaded into the apparatus.

24. The method according to claim 8, wherein the pre-treatment operation is completed in respect of all slides, before said staining operation is initiated in respect of any one of the slides in the frame or case.

25. The method according to claim 8, wherein the stations are stationary within the apparatus, and wherein the frame is positioned relative to the stations by movement of the frame.

26. The method according to claim 8, wherein said pre-treatment operations are selected from: baking, dewaxing, and target retrieval.
